(19) United States
(12) Patent Application Publication
(10) Pub. No.: US 2007/0273848 A1
(43) Pub. Date: Nov. 29, 2007

(54) Portable electronic device having built-in projector

(76) Inventors: Bin Fan, Shanghai (CN); Jianxin Shao, Shanghai (CN)

Correspondence Address: FISH & RICHARDSON PC, P.O. BOX 1022, MINNEAPOLIS, MN, 55440-1022, US

(21) Appl. No.: 11/503,669

(22) Filed: Aug. 14, 2006

(30) Foreign Application Priority Data
May 29, 2006 (CN) 200610083624.X

(51) Int. Cl. G03B 21/14

(52) U.S. Cl. 353/119

(57) ABSTRACT

A portable data processing apparatus includes a storage storing code associated with a computer program that generates at least one of (a) stereoscopic image data and (b) image data associated with images having two groups of primary colors. A keyboard allows a user to input data used by the computer program or entering commands to control execution of the computer program. A built-in digital projector integrated within the portable data processing apparatus projects onto an external display screen at least one of (a) stereoscopic images and (b) images having two groups of primary colors, the built-in digital projector being integrated within the portable data processing apparatus. A microprocessor executes the code and controls the built-in digital projector to project images based on the image data generated by the computer program.

### CROSS-REFERENCE TO RELATED APPLICATIONS

This application claims priority to Chinese application serial no. 200610083624.X, filed May 29, 2006, the contents of which are incorporated by reference. This application is related to concurrently filed U.S. patent application Ser. No. ______, titled “Digital Projector With Timer” (attorney docket 17707-007001), the contents of which are herein incorporated by reference.

### BACKGROUND OF THE INVENTION

The description relates to portable electronic devices having built-in projectors.

Many portable electronic devices, such as portable video game consoles, digital music players, digital cameras, personal digital assistants, and mobile phones, have small displays for showing text messages and images. The displays can be, for example, liquid crystal displays or organic light emitting diode displays. The sizes of the displays mounted on the portable electronic devices are limited by the physical dimensions of the portable devices.

### SUMMARY

In one aspect, in general, a portable digital image capturing apparatus includes an image sensor to generate image signals, a focusing lens to focus light onto the image sensor, a digital projector integrated within the portable digital image capturing apparatus to project images onto an external display screen, a digital signal processor to process the image signals from the image sensor to generate image data that can be stored in a storage, and also to control the built-in digital projector to project images associated with the image data.

Implementations of the portable digital image capturing apparatus may include one or more of the following features. The built-in digital projector includes a light source to generate a light beam, a first light modulator to modulate at least a portion of the light beam, and projection optics for projecting images on the external display screen. The first light modulator includes a liquid crystal layer and an array of dichroic filters, each dichroic filter passing portions of the light beam having wavelengths within a specified range and reflecting portions of the light beam having wavelengths outside of the specified range. The light source includes a light emitting diode. The light source includes multilevel binary optics elements. The binary optics elements includes a fly's eye integrator includes a first array of lens fabricated on a first side of a substrate and a second array of lens fabricated on a second side of the substrate. The digital projector includes a second light modulator to modulate a portion of the light beam, the second light modulator having a liquid crystal layer and an array of dichroic filters. Each of the first and second light modulators includes pixels, each pixel of the first light modulator being associated with dichroic filters that pass a first set of primary colors, and each pixel of the second light modulator being associated with dichroic filters that pass a second set of primary colors. The signal processor processes the image signals from the image sensor to generate stereoscopic image data and controls the digital projector to project stereoscopic images based on the stereoscopic image data.

In another aspect, in general, a portable data processing apparatus includes a storage for storing code associated with a computer program that generates image data, a keyboard for inputting data used by the computer program or entering commands to control execution of the computer program, a built-in digital projector integrated within the portable processing apparatus to project images onto an external display screen, and a microprocessor to execute the code and control the built-in digital projector to project images based on the image data generated by the computer program. The built-in digital projector includes a light source to generate a light beam, a first light modulator to modulate at least a portion of the light beam, and projection optics for projecting images on the external display screen. The light modulator includes a liquid crystal layer and an array of dichroic filters, each dichroic filter passing portions of the light beam having wavelengths within a specified range and reflecting portions of the light beam having wavelengths outside of the specified range.

Implementations of the portable data processing apparatus may include one or more of the following features. The built-in digital projector includes a second light modulator that modulates a portion of the light beam, the second light modulator having a liquid crystal layer and an array of dichroic filters. In some examples, the code is associated with a computer program that generates stereoscopic image data, and the microprocessor executes the code and controls the digital projector to project a stereoscopic image based on the stereoscopic image data. In some examples, each of the first and second light modulator includes pixels, each pixel of the first light modulator being associated with dichroic filters that pass a first set of primary colors, and each pixel of the second light modulator being associated with dichroic filters that pass a second set of primary colors. The light source includes at least one light emitting diode. The light source includes multilevel binary optics elements. The portable data processing apparatus includes at least one of a personal digital assistant, a notebook computer, a mobile phone, a video player, an audio player, and a game console. The computer program includes at least one of an operating system and a video game program.

In another aspect, in general, a portable data processing apparatus includes a storage storing code associated with a computer program that generates at least one of (a) stereoscopic image data and (b) image data associated with images having two groups of primary colors, a keyboard for inputting data used by the computer program or entering commands to control execution of the computer program, a built-in digital projector integrated within the portable data processing apparatus to project onto an external display screen at least one of (a) stereoscopic images and (b) images having two groups of primary colors, the built-in digital projector being integrated within the portable data processing apparatus, and a microprocessor to execute the code and control the built-in digital projector to project images based on the image data generated by the computer program.

Implementations of the portable data processing apparatus may include one or more of the following features. The built-in digital projector includes a light source to generate a light beam, a first light modulator to modulate a portion of the light beam, the light modulator including a liquid crystal layer and an array of dichroic filters, each dichroic filter passing portions of the light beam having wavelengths within a specified range and reflecting portions of the light beam having wavelengths outside of the specified range, a second light modulator that modulates a portion of the light beam, and projection optics for projecting images on the external display screen.

In another aspect, in general, an apparatus includes a light generating device to generate light, a fly's eye integrator including multilevel binary optics elements fabricated on one or more substrates to receive light from the light generating device and provide a light beam having a substantially uniform brightness, a beam splitter to receive the light beam from the fly's eye integrator and provide a first sub-beam and a second sub-beam, a first light modulator to modulate the first sub-beam to generate a first modulated sub-beam, and a second light modulator to modulate the second sub-beam to generate a second modulated sub-beam, wherein the first and second modulated sub-beams are combined to generate an image.

Implementations of the apparatus may include one or more of the following features. The fly's eye integrator includes a first array of lenses and a second array of lenses, the first array of lenses being fabricated on a first side of a substrate, the second array of lenses being fabricated on a second side of the substrate, and each lens in the first and second array of lenses including a multilevel binary optics element.

In another aspect, in general, an apparatus includes a light generating device to generate light, and one or more substrates each having multilevel binary optics elements fabricated thereon, the one or more substrates processing light from the light generating device to provide a spatially uniform illumination, at least one surface of the one or more substrates having an array of lens, each lens includes a multilevel binary optics element.

Implementations of the apparatus may include one or more of the following features. The multilevel binary optics elements perform a function equivalent to a fly's eye integrator.

In another aspect, in general, a method of operating a portable digital image capturing device includes sensing light passing through a focusing lens of the portable digital image capturing device to generate an image signal, generating image data based on the image signal, storing the image data in a storage of the portable digital image capturing device, and projecting, using a built-in projector integrated within the portable digital image capturing device, images onto an external display screen, the images being associated with the image data.

Implementations of the method may include one or more of the following features. Projecting images using the built-in projector includes generating a light beam, modulating at least a portion of the light beam using a first light modulator, the first light modulator including a liquid crystal layer and an array of dichroic filters, each dichroic filter passing portions of the light beam having wavelengths within a specified range and reflecting portions of the light beam having wavelengths outside of the specified range, and projecting light modulated by the first light modulator through projection optics. Projecting images using the built-in projector includes modulating at least a portion of the light beam using a second light modulator, the second light modulator including a liquid crystal layer and an array of dichroic filters. In some examples, the method includes generating a first image having a first set of primary colors from light modulated by the first light modulator and generating a second image having a second set of primary colors from light modulated by the second light modulator. In some examples, the method includes generating a first image from light modulated by the first light modulator, generating a second image from light modulated by the second light modulator, and combining the first and second images into a stereoscopic image that is projected through the projection optics onto the external display screen.

In another aspect, in general, a method of operating a portable data processing apparatus includes executing, using a data processor of the portable data processing apparatus, code associated with a computer program to generate image data; generating a light beam using a built-in light source of the portable data processing apparatus; modulating at least a portion of the light beam by using a first built-in light modulator of the portable data processing apparatus based on the image data, the first built-in light modulator having a liquid crystal layer and an array of dichroic filters, each dichroic filter passing portions of the light beam having wavelengths within a specified range and reflecting portions of the light beam having wavelengths outside of the specified range; projecting, using built-in projection optics of the portable data processing apparatus, images based on light modulated by the first built-in light modulator onto an external display screen; and inputting data or commands through a keyboard of the portable data processing apparatus, the data for use by the computer program, the commands for controlling execution of the computer program to control the images projected onto the external display screen.

Implementations of the portable data processing apparatus may include one or more of the following features. The method includes modulating a portion of the light beam using a second built-in light modulator of the portable data processing apparatus, the second light modulator including a liquid crystal layer and an array of dichroic filters. The computer program generates stereoscopic image data, and projecting images includes projecting stereoscopic images based on the stereoscopic image data. The method includes generating a first image having a first set of primary colors from light modulated by the first built-in light modulator, generating a second image having a second set of primary colors from light modulated by the second built-in light modulator, and combining the first and second images into a combined image that is projected onto the external display screen.

In another aspect, in general, a method of operating a portable data processing apparatus includes executing code associated with a computer program to generate at least one of (a) stereoscopic image data and (b) image data associated with images having two groups of primary colors, generating a light beam using a built-in light source of the portable data processing apparatus, modulating at least a portion of the light beam by using a first built-in light modulator and a second built-in light modulator based on the image data, the first and second built-in light modulators being integrated within the portable data processing apparatus, projecting, using built-in projection optics of the portable data processing apparatus, light modulated by the first and second built-in light modulators to project at least one of (a) stereoscopic images and (b) images having two groups of primary colors onto an external display screen, and inputting, using a keyboard of the portable data processing apparatus, data for use by the computer program or commands for controlling execution of the computer program.

Implementations of the method may include one or more of the following features. Modulating at least a portion of the light beam by using a first built-in light modulator includes directing the portion of the light beam towards a liquid crystal layer and an array of dichroic filters, each dichroic filter passing portions of the light beam having wavelengths within a specified range and reflecting portions of the light beam having wavelengths outside of the specified range.

In another aspect, in general, a method includes passing light through a fly's eye integrator, the fly's eye integrator including multilevel binary optics elements fabricated on one or more substrates to provide a light beam having a substantially uniform brightness, separating the light beam from the fly's eye integrator into a first sub-beam and a second sub-beam, modulating the first sub-beam using a first light modulator to generate a first modulated beam, modulating the second sub-beam using a second light modulator to generate a second modulated beam, and combining the first modulated beam and the second modulated beam to generate a combined beam representing an image.

Implementations of the method may include one or more of the following features. Passing light through a fly's eye integrator includes passing light through a first array of multilevel binary optics elements that are fabricated on a first side of a substrate, and passing light through a second array of multilevel binary optics element that are fabricated on a second side of the substrate.

In another aspect, in general, a method includes generating light using a light source, passing the light through one or more substrates each having multilevel binary optics elements fabricated thereon, at least one surface of the one or more substrates having an array of lens, each lens including a multilevel binary optics element, and processing the light, using the multilevel binary optics elements, to provide a spatially uniform illumination.

Implementations of the method may include one or more of the following features. Processing the light includes spreading and integrating the light to generate the spatially uniform illumination.

Advantages of the portable digital image capturing apparatus include one or more of the following. Having a built-in digital projector allows the user to view a large size image without the need to connect to an external digital projector. The size of the images being projected is not limited by the size of the apparatus (as is the case for a built-in flat panel display), so even a compact portable digital image capturing apparatus can project a large image, allowing the user to more easily view details of the image. The large image can be easily shared with multiple people. Both two-dimensional and stereoscopic images can be projected on an external display screen.

Advantages of multilevel binary optics elements include one or more of the following. The light source of the digital projector can be made small. The binary optics elements can have arbitrary profiles, so it is easier to fabricate binary optics elements that perform the functions of non-spherical discrete optical elements, reducing or preventing aberrations.

Advantages of portable data processing apparatus include one or more of the following. Having a built-in digital projector allows the user to view images without the need to connect to an external digital projector. The built-in digital projector can replace a separate flat panel display. The built-in digital projector may cost less than a separate flat panel display. The built-in digital projector may consume less power than a separate flat panel display, so the portable data processing apparatus may have a longer battery life.

### DESCRIPTION OF DRAWINGS

FIG. 1A shows a digital camera.

FIG. 1B is a diagram of an arrangement of focusing lens and an image sensor.

FIG. 2 shows a digital projector.

FIG. 3 is a schematic diagram of the digital projector.

FIG. 4A is a schematic diagram of a light source.

FIGS. 4B and 4C are schematic diagrams of binary optics elements.

FIGS. 5 and 6 are schematic diagrams of light sources.

FIG. 7 shows a digital camera.

FIG. 8 is a schematic diagram of a digital projector.

FIG. 9A is a perspective view of a portable computer.

FIG. 9B is a block diagram of a portable computer.

FIG. 10 shows a graphics user interface.

FIG. 11 shows a video game console.

FIG. 12 shows a schematic diagram of a digital camera.

### DESCRIPTION

A portable electronic device having a built-in miniature digital projector can project images that are not limited by the size of the portable electronic device. For example, the miniature digital projector may include a miniature light source that has light emitting diodes (LEDs) for generating light, and binary optics devices for collimating and homogenizing the light to generate a homogeneous light beam. The miniature digital projector includes a miniature image generator that uses liquid crystal on silicon (LCOS) microdisplays to modulate the homogeneous light beam to generate images. The LCOS microdisplays can include an array of micro dichroic filters that each pass light of a certain color and reflect light of other colors.

The miniature image generator may include two LCOS microdisplays that are used to generate two images having different sets of three primary colors. The two images can be combined to generate a projected image having six primary colors. The two LCOS microdisplays can also be used to generate a stereoscopic image by combining two images that are intended to be viewed by the left and right eyes, respectively, of a user.

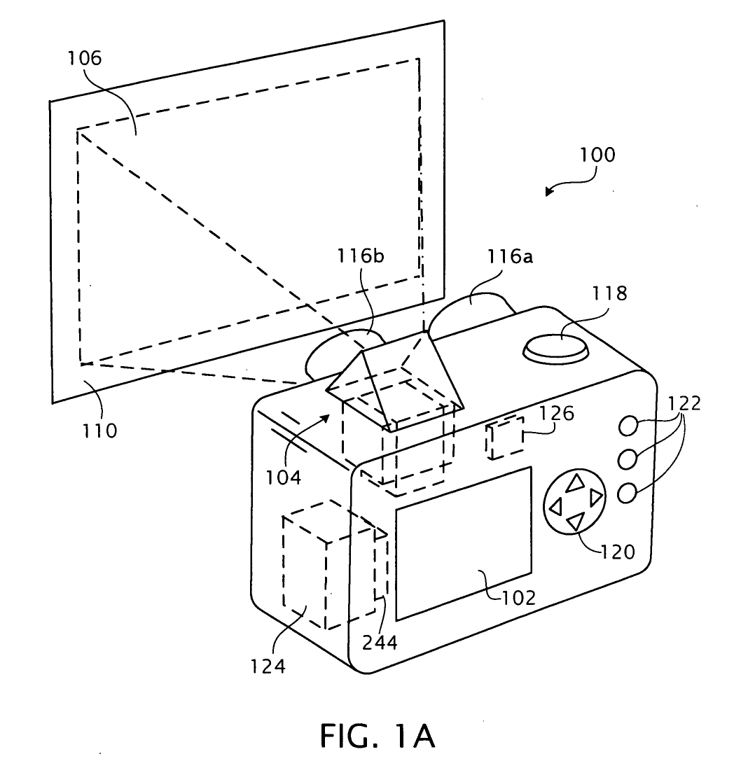

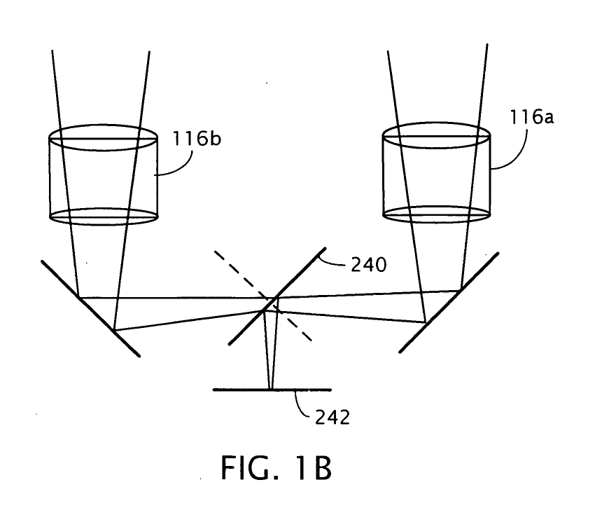

Referring to FIGS. 1A and 1B, an example of a 3D digital camera 100 includes a liquid crystal display (LCD) panel 102 and a built-in digital projector 104. The LCD panel 102 can show a 2D image having a size less than the size of the camera 100, whereas the digital projector 104 can project a 3D image 106 on a screen 110 that can be larger than the size of the camera 100. By having both the LCD panel 102 and the digital projector 104, a user can choose between viewing smaller 2D images directly on the LCD panel 102, larger 3D projected images having higher resolutions, or both.

In some examples, the LCD panel 102 can have a diagonal size of, e.g., 2 inches and a resolution of, e.g., 640×480. The images projected by the digital projector 104 can have a diagonal size of, e.g., 15 inches and a resolution of, e.g., 1280×960.

The digital camera 100 may have a pair of focusing lenses 116a and 116b for focusing a pair of images onto an image sensor 242, e.g., a CMOS or CCD image sensor (FIG. 1B). A swing mirror 240 (FIG. 1B) having adjustable positions can be used to direct light from either the lens 116a or the lens 116b to the image sensor 242. The swing mirror 240 enables the image sensor 242 to capture images focused by the lens 116a and 116b, which correspond to images seen by the right eye and the left eye, respectively, of the user.

A digital signal processor 126 processes the signals from the image sensor 242 to generate image data that can be stored in a storage medium 244, e.g., a flash memory card. The processor 126 controls the display of images by the LCD panel 102 and the projector 104. The camera 100 includes control mechanisms, such as a shutter button 118, menu navigation buttons 120, and operation buttons 122, to control the operation of the camera 100. A battery 124 provides the power for operating the camera 100, including power to the LCD panel 102 and the digital projector 104.

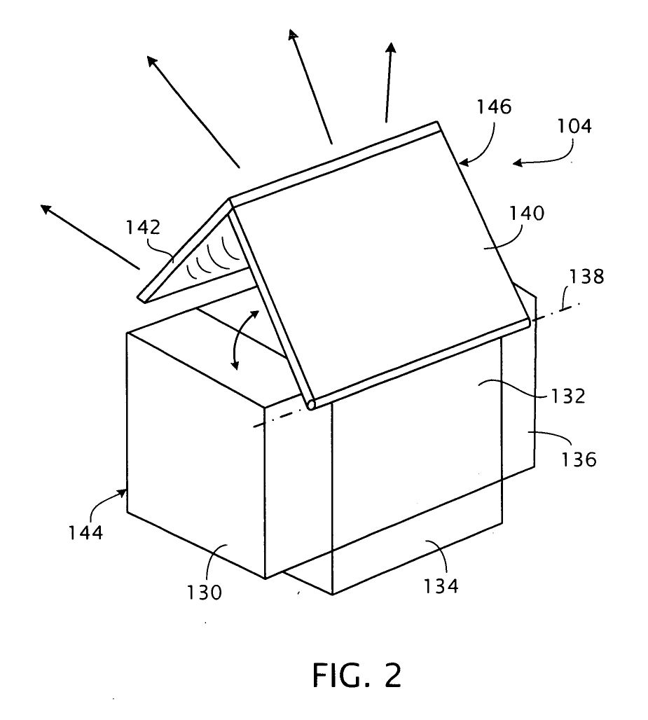

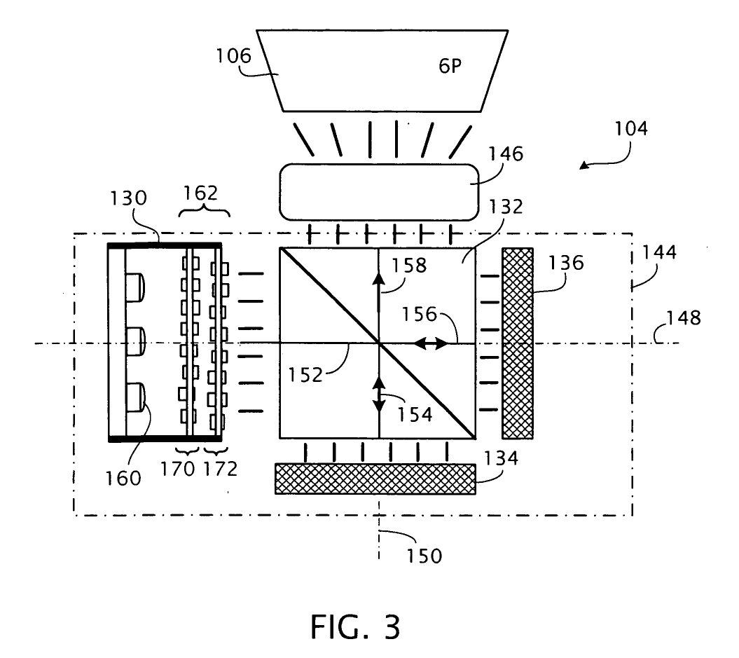

FIG. 2 shows a perspective view of the digital projector 104. FIG. 3 shows a schematic diagram of the digital projector 104. Referring to FIGS. 2 and 3, the digital projector 104 includes an image generator 144 and projection optics 146. The image generator 144 includes a light source 130, a polarizing beam splitter (PBS) 132, a first light modulator 134, and a second light modulator 136. The light source 130, the polarizing beam splitter 132, and the second light modulator 136 are aligned along a first optical axis 148. The first light modulator 150 and the polarizing beam splitter 132 are aligned along a second optical axis 150.

The light source 130 generates a homogeneous light beam 152 having a uniform brightness. The polarizing beam splitter 132 splits the light beam 152 into two beams 154 and 156 having different polarizations. When projecting a 3D image composed of a pair of 2D images captured through the focusing lens 116a and 116b, the first and second light modulators 134 and 136 modulate the light beams 154 and 156 to reproduce the images that are captured through the focusing lenses 116a and 116b, respectively. The images generated by the light modulators 134 and 136 are combined by the PBS 132 into a stereoscopic (3D) image. The stereoscopic image is projected upwards and redirected by the projection optics 146 towards the screen 110.

The stereoscopic image includes two images projected by light having different polarizations. For example, one image intended for the left eye may have a horizontal polarization, and the other image intended for the right eye may have a vertical polarization. The user can view the stereoscopic image using a pair of eyeglasses in which the left and right eye pieces allow passage of light having horizontal and vertical polarizations, respectively.

The projection optics 146 can include, e.g., a mirror 140 and a lens module 142. The mirror 140 reflects light from the image generator 144 so that the upward projected image is redirected in a forward direction towards the screen 110. The projection optics 146 is coupled to the camera body through hinges such that the projection optics 146 are rotatable about an axis 138 (FIG. 2). The projection direction of the image 110 can be adjusted by rotating the projection optics 146 relative to the axis 138. The lens module 142 focuses the projected image 106 on the screen 110. The projection optics 146 can be folded into the camera body when not in use.

The light source 130 can include, for example, light emitting diodes (LEDs) 160 for generating light. The LEDs 160 can be one or more white LEDs, or a combination of red, green, and blue LEDs. Light emitted from the LEDs 160 can be collimated and homogenized using, for example, a combination 162 of a collimating lens 170 and a fly's eye integrator 172. The collimating lens 170 and/or the fly's eye integrator 172 can be made of, e.g., multi-step binary optics devices that are fabricated on one or more substrates using photolithography methods.

The light modulators 134 and 136 can be, for example, liquid crystal on silicon (LCOS) microdisplays each having a resolution of, e.g., 1280×960. Depending on the resolution and the size of each pixel cell, the LCOS microdisplays can have a diagonal size of, e.g., 0.3 to 1.8 inches. The light source 130 and the PBS 132 have dimensions that match the dimensions of the LCOS microdisplays 134 and 136, so the overall size of the digital projector 104 can be made small. The LCOS microdisplays can use an array of dichroic color filters to generate color images.

Each of the LCOS microdisplays 134 and 136 includes a silicon substrate having pixel circuits disposed thereon, an array of metal reflectors, a liquid crystal layer, a layer of transparent electrode, an array of micro dichroic filters, and a cover substrate. Each dichroic filter allows light of a certain color (i.e., light within a certain range of wavelengths) to pass, and reflects light of other colors. In some examples, each pixel of the microdisplay includes three sub-pixels, each sub-pixel corresponding to one of three dichroic filters that allow red, green, and blue colors to pass, respectively. Such pixels can exhibit colors composed of red, green, and blue colors. In some examples, each pixel includes three sub-pixels, each sub-pixel corresponding to one of three dichroic filters that allow cyan, magenta, and yellow colors to pass, respectively. Such pixels can exhibit colors composed of cyan, magenta, and yellow colors.

When a white light beam from the light source 130 irradiates a sub-pixel of the LCOS microdisplay, a portion of the light beam not within the pass band of the dichroic filter is reflected without changing its polarization. The portion of the light beam that passes the dichroic filter passes the liquid crystal layer, is reflected by the metal reflector, then passes the liquid crystal layer and the dichroic filter a second time. As light passes the liquid crystal layer, the polarization of the light may change, depending on the orientation of the liquid crystal molecules in the liquid crystal layer, which in turn is controlled by the voltage applied across the liquid crystal layer.

The light that passes the dichroic filters are modulated by the liquid crystal layer to form an image that is projected on the screen 110 through the projection optics 146. The light that is reflected from the dichroic filters can be recycled to increase optical efficiency.

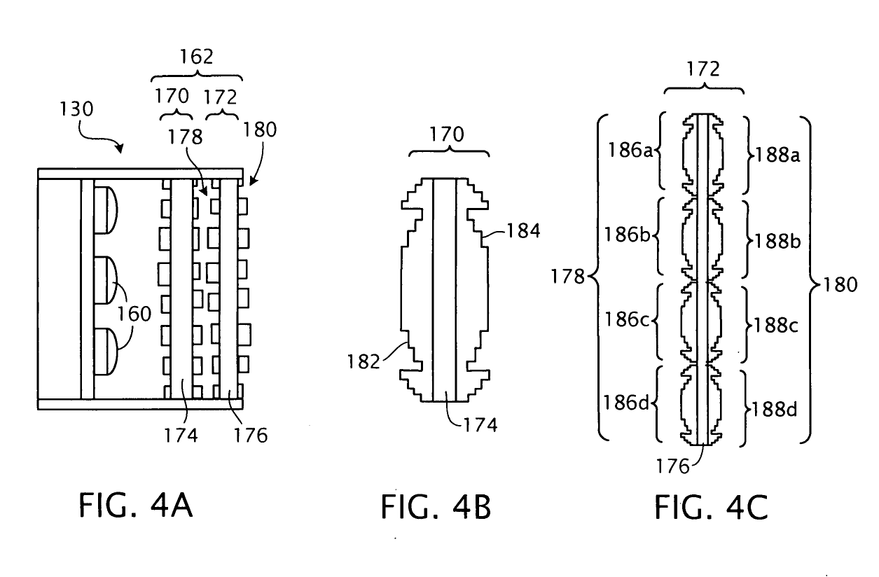

Referring to FIG. 4A, in some examples, the collimating lens 170 is fabricated on a first glass substrate 174, and the fly's eye integrator 172 is fabricated on a second glass substrate 176. The fly's eye integrator 172 includes a first fly's eye lens array 178 fabricated on a first side of the glass substrate 176, and a second fly's eye lens array 180 fabricated on a second side of the glass substrate 176.

Referring to FIG. 4B, the collimating lens 170 is a binary optics element that has multiple levels. The collimating lens 170 includes a multilevel surface profile 182 on one side of the substrate 174 and a multilevel surface profile 184 on another side of the substrate 174. The multilevel surface profile 182 performs a function equivalent to a first convex surface of a discrete convex lens, and the multilevel surface profile 184 performs a function equivalent to a second convex surface of the discrete convex lens. The collimating lens 172 can perform a function equivalent to a spherical lens or a non-spherical lens.

Referring to FIG. 4C (which is not to scale), the first fly's eye lens array 178 includes an array of lenses, such as 186a to 186d. The second fly's eye lens array 180 includes an array of lenses, such as 188a to 188d. Each lens 186a-186d and 188a-188d is a binary optics element that has multiple levels. The lenses are fabricated using photolithography techniques. Each of the lens in the arrays 178 and 180 can perform a function equivalent to a spherical lens or a non-spherical lens.

Advantages of using multi-step binary optics devices is that the collimating lens 170 and/or the fly's eye integrator 172 can be made thin, so that the overall size of the light source 130 can be made small. The collimating lens 170 and the fly's eye integrator 172 can be built into the front cover of the light source 130. The binary optics elements can have arbitrary profiles, so it is easier to fabricate binary optics elements that perform the functions of non-spherical discrete optical elements, reducing or preventing aberrations.

Using photolithography methods to fabricate the binary optics devices enables each lens in the array of lenses to be made small, e.g., having 100 μm in diameter. Light emitted from each LED passes through several small lenses, in which light passing different lens overlap one another to produce homogeneous light. Mass-producing the binary optics devices using photolithography techniques also reduces the cost of the collimating lens 170 and the fly's eye integrator 172.

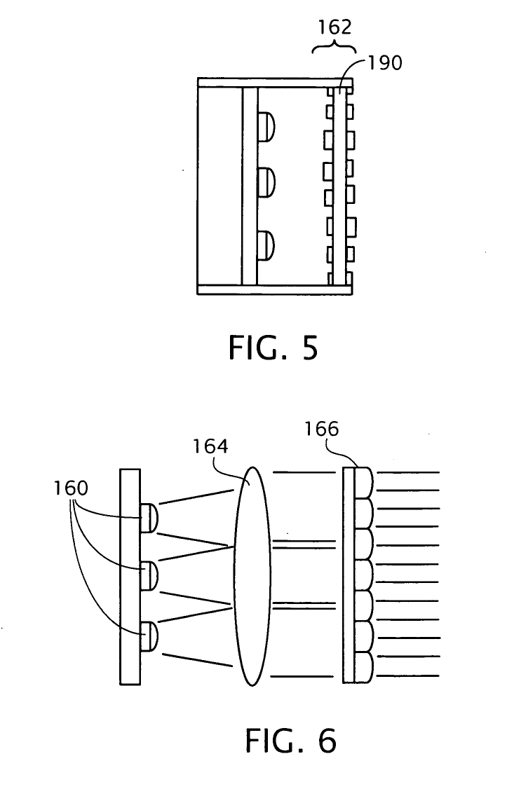

Referring to FIG. 5, the combination 162 of the collimating lens and the fly's eye integrator can be fabricated on a single substrate 190.

For a slightly larger camera, the light source 130 can use conventional lens, as shown in FIG. 6. A collimating lens 164 collimates light emitted from the LEDs 160. A fly's eye array 166 homogenizes the collimated light to generate a homogeneous light beam having a uniform brightness.

Examples of LCOS microdisplays are described in International Application No. PCT/CN03/00348, filed on May 14, 2003, and corresponding U.S. patent application Ser. No. 10/506,264, titled “A SILICON-BASED COLOR LIQUID CRYSTAL DISPLAY MICRODEVICE,” filed on Oct. 8, 2004, the contents of which are incorporated by reference.

Examples of microdisplays that use interference filter arrays are described in U.S. patent application Ser. No. 11/141,737, filed Jun. 1, 2005, titled “FILTER ARRAYS FOR LIQUID CRYSTAL DISPLAYS AND METHODS OF MAKING THE SAME,” the contents of which are incorporated by reference.

Examples of projection display systems that utilize LCOS microdisplays are described in International Application No. PCT/CN2004/000110 filed on Feb. 10, 2004, and corresponding U.S. patent application Ser. No. 10/506,304, titled “A COLOR PROJECTION DISPLAY SYSTEM,” filed on Sep. 1, 2004, the contents of which are incorporated by reference.

The camera 100 can be operated to capture 2D images through one focusing lens 116a. The digital projector 104 can project 2D images by sending the same image signal to the first and second light modulators 134 and 136.

Advantages of the camera 100 include the following. The size of the images being projected is not limited by the size of the camera 100, so even a compact camera can project a large image. The projected image 106 can have a larger size and a higher resolution (than images shown on the LCD panel 102), so the user can more easily view details of the images captured by the camera 100. It is also easier to share the large projected images with multiple people. Stereoscopic images can be projected on an external display screen 110.

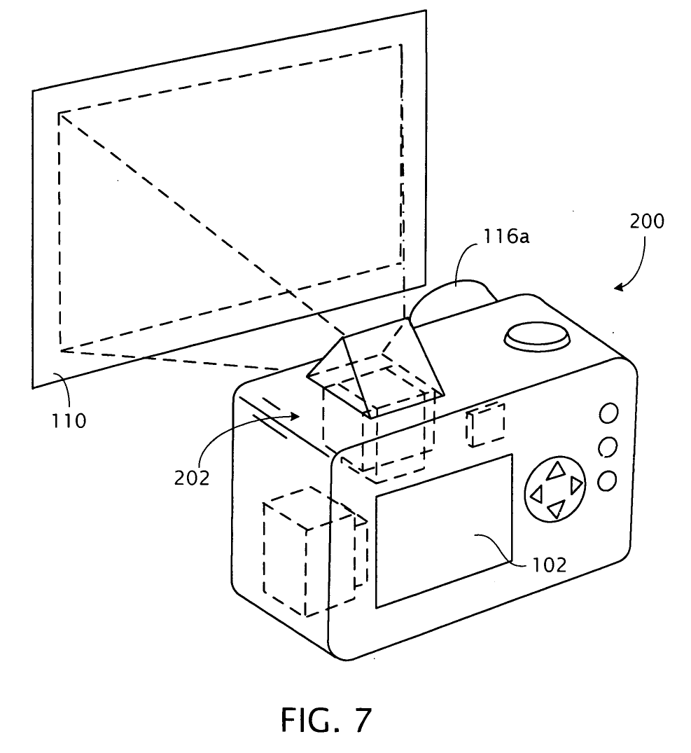

FIG. 7 shows an example of a digital camera 200 that is similar to the digital camera 100 except that the camera 200 has one focusing lens 116a for focusing light onto one image sensor. The digital camera 200 captures 2D images and projects 2D images using a digital projector 202.

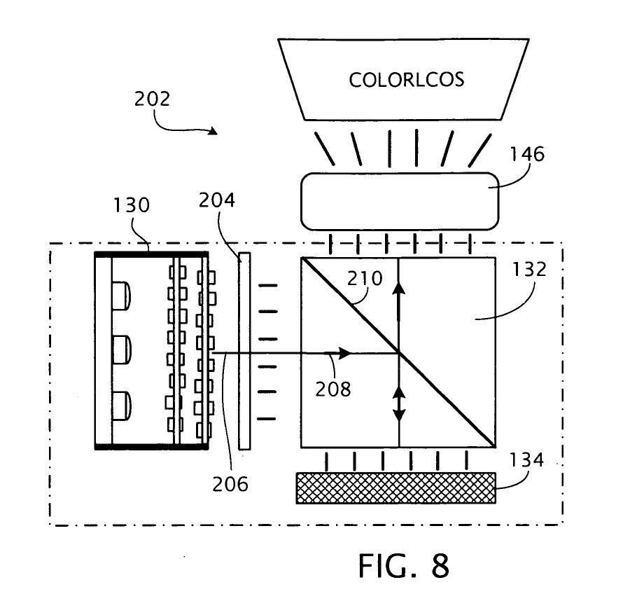

FIG. 8 shows a schematic diagram of the digital projector 202, which is similar to the digital projector 104 except that the projector 202 has only one light modulator 134 and has an additional polarizer 204. A light source 130 generates a homogeneous light beam 206 that passes the polarizer 204, generating a polarized light beam 208. A polarizing beam splitting surface 210 directs the polarized light beam 208 towards the light modulator 134, which modulates the light beam 208 to generate an image. The modulated light is projected upwards and redirected by the projection optics 146 towards a display screen 110.

The digital camera 200 can also use the digital projector 104. In this case, the light modulators 134 and 136 receive the same image signal so that the projected images are 2D images.

Because of their small sizes, the digital projectors 104 and 202 can be used in many portable electronic devices.

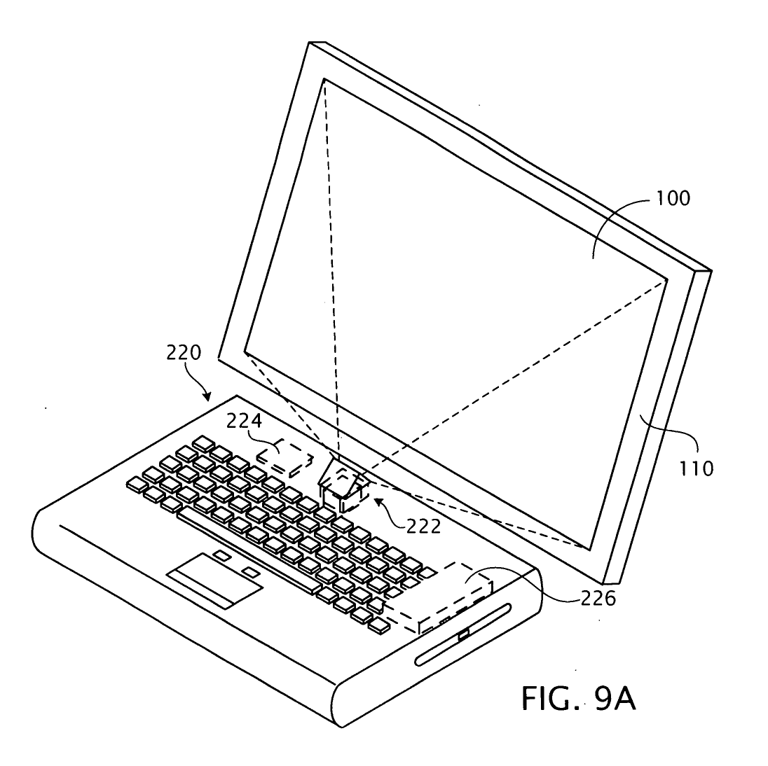

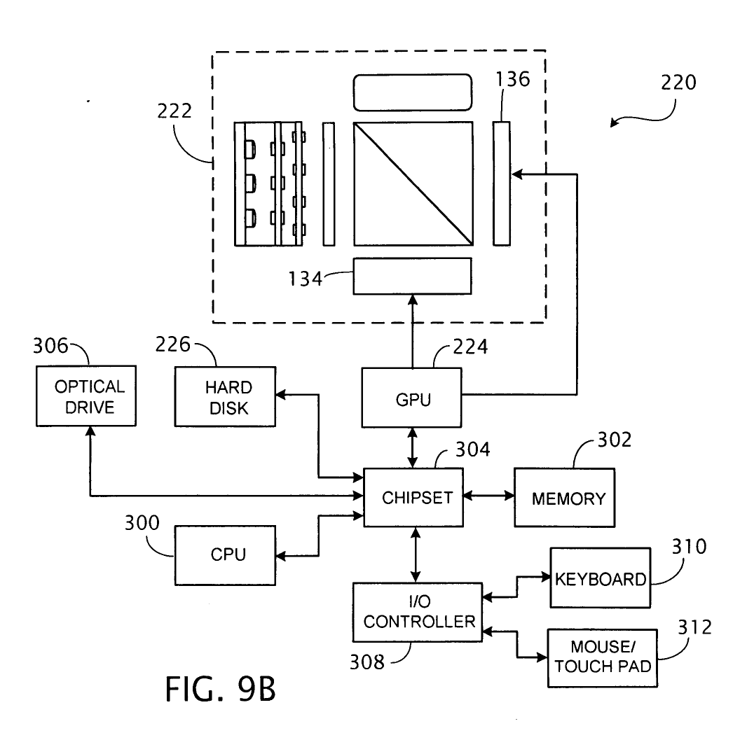

FIG. 9A is a perspective view of an example of a portable computer 220 that includes a built-in digital projector 222 that can project images 106 having sizes larger than the portable computer 220 (the drawing is not to scale). The digital projector 222 is similar to the digital projector 104, and has a first light modulator 134 and a second light modulator 136 (see FIG. 3). FIG. 9B is a block diagram of the portable computer 220.

The portable computer 220 includes a graphics processing unit (GPU) 224 for controlling the digital projector 222. The GPU 224 can control the digital projector 222 to project 3D images by sending pairs of images to the light modulators 134 and 136, in which each pair of images correspond to images intended to be seen by the left and right eyes, respectively, of the user. The GPU 224 can also control the digital projector 222 to project 2D images by sending the same image signal to the light modulators 134 and 136.

In some examples, the first light modulator 134 is configured to modulate a first polarized beam 154 such that the first modulated beam has a first set of three primary colors—red, green, and blue. The second light modulator 136 is configured to modulate a second polarized beam 156 such that the second modulated beam has a second set of three primary colors—cyan, magenta, and yellow.

The GPU 224 can control the digital projector 222 to project 2D images having six primary colors, referred to as 6P images. For example, a 6P image can have red, green, blue, cyan, magenta, and yellow colors. The GPU 224 can send an image signal representing the red, green, and blue color components of the 6P image to the first light modulator 134, and send an image signal representing the cyan, magenta, and yellow color components of the 6P image to the second light modulator 136. The projected image 106 includes modulated light from the first and second light modulators 134 and 136, and thus has six primary colors, resulting in an image having richer colors than if the image were composed of only three primary colors. Showing images using six primary colors can be useful in displaying photographs with accurate colors.

The portable computer 220 includes a central processing unit (CPU) 300 for executing code, such as code for an operating system and application programs. The code is stored in a hard disk drive 226 and loaded into a memory 302 during execution by the CPU 300. An optical disc drive 306 allows reading data from and writing data to optical discs. The optical disc drive 306 can be used to view videos, such as movies, and play video games stored on optical discs. A chipset controller 304 (or a number of chipset controllers) communicates with the CPU 300 and controls access to the hard disk drive 226, the optical disc drive 306, the GPU 224, and the memory 302. The chipset controller 304 is connected to an input/output controller 308 that connects to a keyboard 310 and a mouse or touch pad 312. The keyboard 310 allows a user to enter data for use by the operating system and application programs or to control execution of the operating system and the application programs. The operating system provides a graphical user interface (GUI) that includes windows for displaying the outputs of application programs.

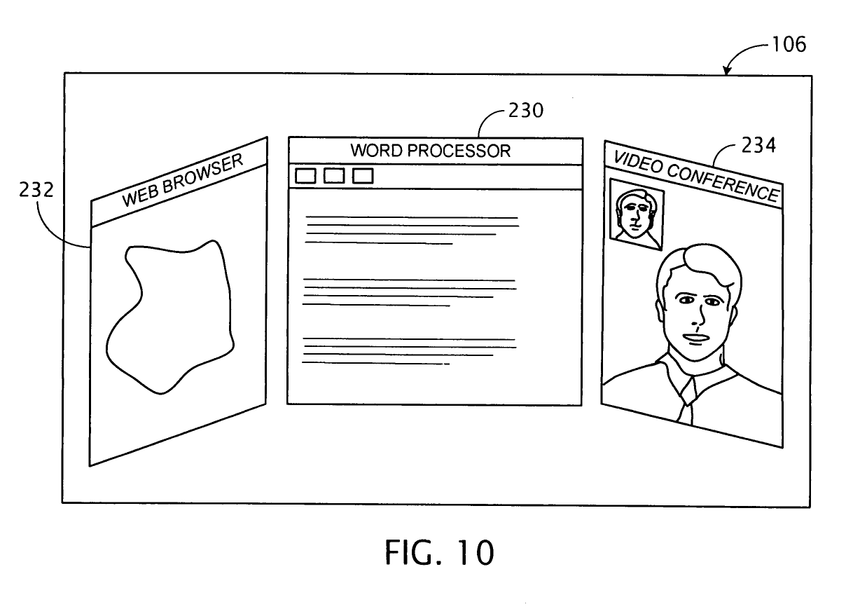

Referring to FIG. 10, for example, a first window 230 may display the output of a word processing program, a second window 232 may display the output of a web browser, and a third window 234 may display the output of a video conferencing program.

The operating system may generate image signals to enable the windows 230, 232, and 234 to be shown in three dimension. The operating system generates a first image signal representing a first image of the windows 230, 232, and 234 as seen by the left eye of the user, and a second image signal representing a second image of the windows 230, 232, and 234 as seen by the right eye of the user. The GPU controls the first and second light modulators 134 and 136 using the first and second image signals, respectively, so that the digital projector 222 projects a stereoscopic image 106 on the screen 110, showing the windows 230, 232, and 234 in three dimension.

The hard disk drive 226 may store code of a video game program that generates 3D images in a video game. For each scene in the video game, the video game program generates a first image signal representing a first view of the scene as seen by the left eye of the user, and a second image signal representing a second view of the scene as seen by the right eye of the user. The GPU 224 controls the first and second light modulators 134 and 136 using the first and second image signals, respectively, so that the digital projector 222 projects a 3D image 106 on the screen 110, showing the scene in three dimension.

The operating system may include a timer application that keeps track of the duration that 3D images are projected by the digital projector 222. Viewing 3D images may cause more stress to the eyes, as compared to viewing 2D images. The operating system can be configured to show 3D images continuously for a first preset period of time, then switch to showing 2D images for a second preset period of time to allow the eyes to rest, then switch back to showing 3D images for the first preset period of time, and so forth. For example, the first preset period of time can be 10 minutes, and the second preset period of time can be 1 minute.

The timer is useful when playing video games, in which the user often concentrates on the game and does not keep track of time. Without the timer, the user may view 3D images for a prolonged period of time, causing harm to the eyes.

The operating system may cause a reminder message (e.g., “You have been viewing 3D images for over n minutes” or “Please take a rest or switch to 2D images”) to be shown as part of the projected image 106 when 3D images have been continuously projected by the digital projector 222 for a preset amount of time. For example, the operating system can also cause the portable computer to output a beeping sound, output a blinking icon on the screen, cause an LED to blink, or show a countdown of a timer to remind the user that 3D images have been shown for a long period of time. The operating system lets the user decide whether to continue to view 3D images or switch to viewing 2D images.

Because a built-in digital projector can have small sizes, a portable computer can have more than one built-in digital projector for some special applications.

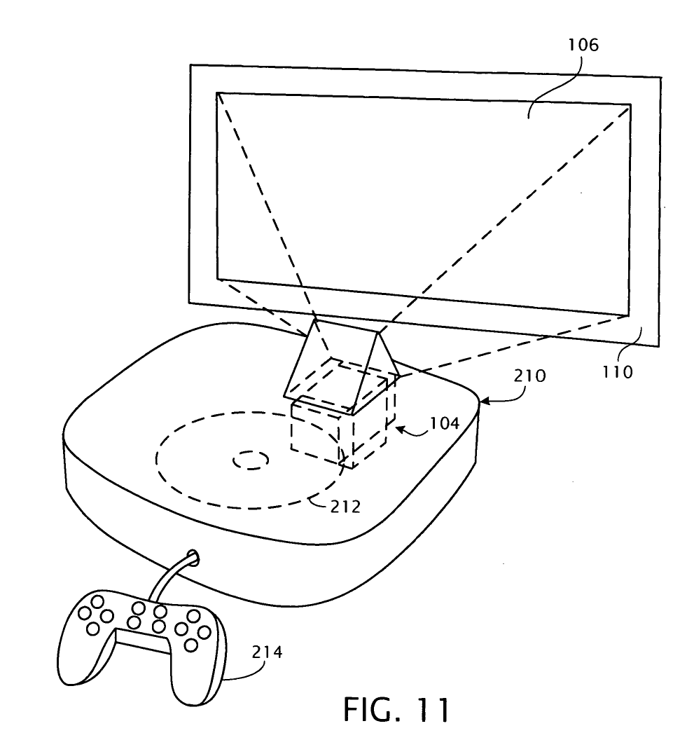

FIG. 11 shows an example of a portable video game console 210 that can be used to play games stored on a storage medium 212, such as an optical disc. The user controls movements of characters in the game using a joystick, steering wheel, or game pad 214. The storage medium 212 can comply with, e.g., Digital Video Disc (DVD), High Definition DVD (HD-DVD), or Blu-ray Disc standard. The storage medium can be read-only, write-once, or rewritable.

The game console 210 includes a built-in digital projector 104 that can project images 106 onto an external display screen 110. The digital projector 104 can be configured to project 2D or 3D images. The digital projector 104 can include light modulators 134 and 136 that are configured such that the projected images are compatible with, e.g., VGA standard (640×480 pixels), XGA standard (1024×768 pixels), SXGA standard (1280×1024 pixels), UXGA standard (1600×1200 pixels), WXGA standard (1366×768 pixels), or HDTV standard (1280×720 or 1920×1080 pixels). Using the digital projector 104, the portable video game console 210 can project images or videos having a higher resolution than if a conventional small size flat panel display were used. The digital projector 104 can project stereoscopic images or images having two sets of primary colors (e.g., red, green, blue, cyan, magenta, and yellow).

The video game console 210 can also be used to show movies stored on the storage medium 212.

### ALTERNATIVE EXAMPLES

Although some examples have been discussed above, other implementations and applications are also within the scope of the following claims. For example, the digital cameras 100 and 200 can be configured to include only the digital projector 104 and 202, respectively, without including the LCD panel 102. The fly's eye integrator 172 in FIG. 3 can be replaced by a rod integrator. In the digital projectors 104 (FIG. 2) and 202 (FIG. 8), the LEDs 160 can be replaced by other light generators, such as a light pipe. The digital projector 104 and 202 can be used in devices other than those described above, such as a digital camcorder, portable phone, a land line telephone, a personal digital assistant, a portable music player, a portable radio, a portable video player, or a digital photo frame. The digital projectors 104 and 202 can be used to replace flat panel displays of personal computers.

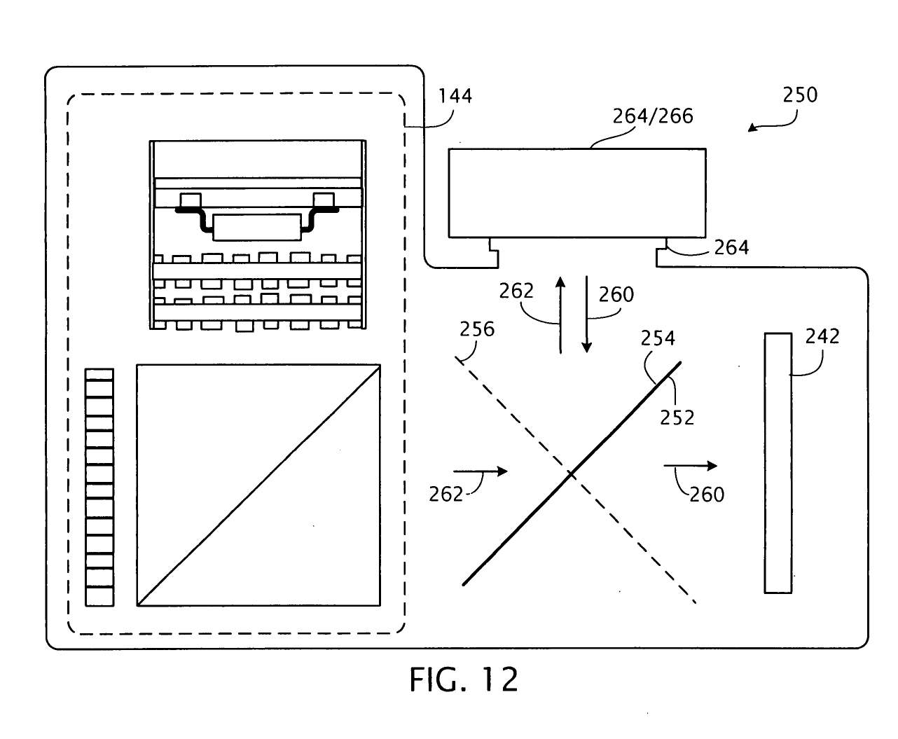

The camera 100 of FIG. 1A uses focusing lens 116a and 116b for focusing the images to be captured by the image sensor 242, and projection optics 146 for focusing images to be projected on the external display screen. In some examples, the projection optics and one of the focusing lens 116a or 116b can share a common lens mount. Referring to FIG. 12, a digital camera 250 includes a image sensor 242, an image generator 144, a swing mirror 252, and a lens mount 264. When the user intends to take a picture, a focusing lens 264 is attached to the lens mount 264, and the swing mirror 252 is adjusted to a position 256. Incoming light 260 that passes the focusing lens 264 is directed towards the image sensor 242. When the user intends to view a projected image, a projection lens 266 is attached to the lens mount 264, and the swing mirror 252 is adjusted to a position 254. Light 262 from the image generator 144 is directed towards the projection lens 266 and projected onto an external display screen. The camera 200 of FIG. 7 can also be modified such that the focusing lens and the projection lens share a common lens mount.

What is claimed is:

1. A portable digital image capturing apparatus comprising:
an image sensor to generate image signals;
a focusing lens to focus light onto the image sensor;
a digital projector integrated within the portable digital image capturing apparatus to project images onto an external display screen; and
a digital signal processor to process the image signals from the image sensor to generate image data that can be stored in a storage, and also to control the built-in digital projector to project images associated with the image data.

2. The digital image capturing apparatus of claim 1 wherein the built-in digital projector comprises:
a light source to generate a light beam,
a first light modulator to modulate at least a portion of the light beam, the first light modulator comprising a liquid crystal layer and an array of dichroic filters, each dichroic filter passing portions of the light beam having wavelengths within a specified range and reflecting portions of the light beam having wavelengths outside of the specified range, and
projection optics for projecting images on the external display screen.

3. The digital image capturing apparatus of claim 2 wherein the light source comprises a light emitting diode.

4. The digital image capturing apparatus of claim 2 wherein the light source comprises multilevel binary optics elements.

5. The digital image capturing apparatus of claim 2 wherein the binary optics elements comprise a fly's eye integrator comprising a first array of lens fabricated on a first side of a substrate and a second array of lens fabricated on a second side of the substrate.

6. The digital image capturing apparatus of claim 2 wherein the digital projector comprises a second light modulator to modulate a portion of the light beam, the second light modulator having a liquid crystal layer and an array of dichroic filters.

7. The digital image capturing apparatus of claim 6 wherein each of the first and second light modulators comprises pixels, each pixel of the first light modulator being associated with dichroic filters that pass a first set of primary colors, and each pixel of the second light modulator being associated with dichroic filters that pass a second set of primary colors.

8. The digital image capturing apparatus of claim 6 wherein the digital signal processor processes the image signals from the image sensor to generate stereoscopic image data and controls the digital projector to project stereoscopic images based on the stereoscopic image data.

9. A portable data processing apparatus comprising:
a storage for storing code associated with a computer program that generates image data;
a keyboard for inputting data used by the computer program or entering commands to control execution of the computer program;
a built-in digital projector integrated within the portable processing apparatus to project images onto an external display screen, the built-in digital projector comprising
a light source to generate a light beam, and
a first light modulator to modulate at least a portion of the light beam, the light modulator comprising a liquid crystal layer and an array of dichroic filters, each dichroic filter passing portions of the light beam having wavelengths within a specified range and reflecting portions of the light beam having wavelengths outside of the specified range, and
projection optics for projecting images on the external display screen; and
a microprocessor to execute the code and control the built-in digital projector to project images based on the image data generated by the computer program.

10. The portable data processing apparatus of claim 9 wherein the built-in digital projector comprises a second light modulator that modulates a portion of the light beam, the second light modulator having a liquid crystal layer and an array of dichroic filters.

11. The portable data processing apparatus of claim 10 wherein the code is associated with a computer program that generates stereoscopic image data, and the microprocessor executes the code and controls the digital projector to project a stereoscopic image based on the stereoscopic image data.

12. The portable data processing apparatus of claim 10 wherein each of the first and second light modulator comprises pixels, each pixel of the first light modulator being associated with dichroic filters that pass a first set of primary colors, and each pixel of the second light modulator being associated with dichroic filters that pass a second set of primary colors.

13. The portable data processing apparatus of claim 9 wherein the light source comprises at least one light emitting diode.

14. The portable data processing apparatus of claim 9 wherein the light source comprises multilevel binary optics elements.

15. The portable data processing apparatus of claim 9 wherein the portable data processing apparatus comprises at least one of a personal digital assistant, a notebook computer, a mobile phone, a video player, an audio player, and a game console.

16. The portable data processing apparatus of claim 9 wherein the computer program comprises at least one of an operating system and a video game program.

17. A portable data processing apparatus comprising:
a storage storing code associated with a computer program that generates at least one of (a) stereoscopic image data and (b) image data associated with images having two groups of primary colors;
a keyboard for inputting data used by the computer program or entering commands to control execution of the computer program;
a built-in digital projector integrated within the portable data processing apparatus to project onto an external display screen at least one of (a) stereoscopic images and (b) images having two groups of primary colors, the built-in digital projector being integrated within the portable data processing apparatus; and
a microprocessor to execute the code and control the built-in digital projector to project images based on the image data generated by the computer program.

18. The portable data processing apparatus of claim 17 wherein the built-in digital projector comprises:
a light source to generate a light beam,
a first light modulator to modulate a portion of the light beam, the light modulator comprising a liquid crystal layer and an array of dichroic filters, each dichroic filter passing portions of the light beam having wavelengths within a specified range and reflecting portions of the light beam having wavelengths outside of the specified range,
a second light modulator that modulates a portion of the light beam, and
projection optics for projecting images on the external display screen.

19. An apparatus comprising:
a light generating device to generate light;
a fly's eye integrator comprising multilevel binary optics elements fabricated on one or more substrates to receive light from the light generating device and provide a light beam having a substantially uniform brightness;
a beam splitter to receive the light beam from the fly's eye integrator and to provide a first sub-beam and a second sub-beam;
a first light modulator to modulate the first sub-beam to generate a first modulated sub-beam; and
a second light modulator to modulate the second sub-beam to generate a second modulated sub-beam, wherein the first and second modulated sub-beams are combined to generate an image.

20. The apparatus of claim 19 wherein the fly's eye integrator comprises a first array of lenses and a second array of lenses, the first array of lenses being fabricated on a first side of a substrate, the second array of lenses being fabricated on a second side of the substrate, and each lens in the first and second array of lenses comprises a multilevel binary optics element.

21. An apparatus comprising:
a light generating device to generate light; and
one or more substrates each having multilevel binary optics elements fabricated thereon, the one or more substrates processing light from the light generating device to provide a spatially uniform illumination, at least one surface of the one or more substrates having an array of lens, each lens comprising a multilevel binary optics element.

22. The apparatus of claim 21 wherein the multilevel binary optics elements perform a function equivalent to a fly's eye integrator.

23. A method of operating a portable digital image capturing device, the method comprising:
sensing light passing through a focusing lens of the portable digital image capturing device to generate an image signal;
generating image data based on the image signal;
storing the image data in a storage of the portable digital image capturing device; and
projecting, using a built-in projector integrated within the portable digital image capturing device, images onto an external display screen, the images being associated with the image data.

24. The method of claim 23 wherein projecting images using the built-in projector comprises:
generating a light beam,
modulating at least a portion of the light beam using a first light modulator, the first light modulator comprising a liquid crystal layer and an array of dichroic filters, each dichroic filter passing portions of the light beam having wavelengths within a specified range and reflecting portions of the light beam having wavelengths outside of the specified range, and
projecting light modulated by the first light modulator through projection optics.

25. The method of claim 24 wherein projecting images using the built-in projector comprises modulating at least a portion of the light beam using a second light modulator, the second light modulator comprising a liquid crystal layer and an array of dichroic filters.

26. The method of claim 25, further comprising generating a first image having a first set of primary colors from light modulated by the first light modulator and generating a second image having a second set of primary colors from light modulated by the second light modulator.

27. The method of claim 25, further comprising generating a first image from light modulated by the first light modulator, generating a second image from light modulated by the second light modulator, and combining the first and second images into a stereoscopic image that is projected through the projection optics onto the external display screen.

28. A method of operating a portable data processing apparatus, the method comprising:
executing, using a data processor of the portable data processing apparatus, code associated with a computer program to generate image data;
generating a light beam using a built-in light source of the portable data processing apparatus;
modulating at least a portion of the light beam by using a first built-in light modulator of the portable data processing apparatus based on the image data, the first built-in light modulator having a liquid crystal layer and an array of dichroic filters, each dichroic filter passing portions of the light beam having wavelengths within a specified range and reflecting portions of the light beam having wavelengths outside of the specified range;
projecting, using built-in projection optics of the portable data processing apparatus, images based on light modulated by the first built-in light modulator onto an external display screen; and
inputting data or commands through a keyboard of the portable data processing apparatus, the data for use by the computer program, the commands for controlling execution of the computer program to control the images projected onto the external display screen.

29. The method of claim 28, further comprising modulating a portion of the light beam using a second built-in light modulator of the portable data processing apparatus, the second light modulator comprising a liquid crystal layer and an array of dichroic filters.

30. The method of claim 29 wherein the computer program generates stereoscopic image data, and projecting images comprises projecting stereoscopic images based on the stereoscopic image data.

31. The method of claim 29, further comprises generating a first image having a first set of primary colors from light modulated by the first built-in light modulator, generating a second image having a second set of primary colors from light modulated by the second built-in light modulator, and combining the first and second images into a combined image that is projected onto the external display screen.

32. A method of operating a portable data processing apparatus, the method comprising:
executing code associated with a computer program to generate at least one of (a) stereoscopic image data and (b) image data associated with images having two groups of primary colors;
generating a light beam using a built-in light source of the portable data processing apparatus;
modulating at least a portion of the light beam by using a first built-in light modulator and a second built-in light modulator based on the image data, the first and second built-in light modulators being integrated within the portable data processing apparatus;
projecting, using built-in projection optics of the portable data processing apparatus, light modulated by the first and second built-in light modulators to project at least one of (a) stereoscopic images and (b) images having two groups of primary colors onto an external display screen; and
inputting, using a keyboard of the portable data processing apparatus, data for use by the computer program or commands for controlling execution of the computer program.

33. The method of claim 29 wherein modulating at least a portion of the light beam by using a first built-in light modulator comprises directing the portion of the light beam towards a liquid crystal layer and an array of dichroic filters, each dichroic filter passing portions of the light beam having wavelengths within a specified range and reflecting portions of the light beam having wavelengths outside of the specified range.

34. A method comprising:
passing light through a fly's eye integrator, the fly's eye integrator comprising multilevel binary optics elements fabricated on one or more substrates to provide a light beam having a substantially uniform brightness;
separating the light beam from the fly's eye integrator into a first sub-beam and a second sub-beam;
modulating the first sub-beam using a first light modulator to generate a first modulated beam;
modulating the second sub-beam using a second light modulator to generate a second modulated beam; and
combining the first modulated beam and the second modulated beam to generate a combined beam representing an image.

35. The method of claim 34 wherein passing light through a fly's eye integrator comprises passing light through a first array of multilevel binary optics elements that are fabricated on a first side of a substrate, and passing light through a second array of multilevel binary optics element that are fabricated on a second side of the substrate.

36. A method comprising:
generating light using a light source;
passing the light through one or more substrates each having multilevel binary optics elements fabricated thereon, at least one surface of the one or more substrates having an array of lens, each lens comprising a multilevel binary optics element; and
processing the light, using the multilevel binary optics elements, to provide a spatially uniform illumination.

37. The method of claim 36 wherein processing the light comprises spreading and integrating the light to generate the spatially uniform illumination.
